(19) United States
(12) Patent Application Publication
(10) Pub. No.: US 2026/0276909 A1
(43) Pub. Date: Sep. 17, 2026

(54) Tapers In Optical Chip-to-Chip Interconnects

(71) Applicant: Tectus Corporation, Cupertino, CA (US)

(72) Inventor: Brian Elliot Lemoff, Morgan Hill, CA (US)

(21) Appl. No.: 19/426,039

(22) Filed: Dec. 18, 2025

Related U.S. Application Data
(60) Provisional application No. 63/770,286, filed on Mar. 11, 2025.

(51) Int. Cl. G02B 6/42; H04B 10/50; H04B 10/69

(52) U.S. Cl. CPC G02B 6/4212; G02B 6/4239; G02B 6/4242; G02B 6/4249; H04B 10/502; H04B 10/691

(57) ABSTRACT

Data channels may be served by bundles of optical fibers which carry optical signals from transmitters to receivers. The emitters and detectors may or may not be aligned to the cores of the optical fibers. In either case, light from emitters is coupled into optical fibers, and light exiting fibers is coupled onto detectors. Tapers, rather than microlenses, may perform this task. An array of tapers provides a flat surface to which fibers or fiber bundles may be glued without leaving air gaps. Tapers may be manufactured with standard semiconductor processing techniques.

### CROSS-REFERENCE TO RELATED APPLICATION(S)

This application claims priority under 35 U.S.C. § 119(e) to U.S. Provisional Patent Application Ser. No. 63/770,286, “Tapers In Optical Chip-to-Chip Interconnects,” filed Mar. 11, 2025. The subject matter of all of the foregoing is incorporated herein by reference in its entirety.

### BACKGROUND

The advent of large language models for artificial intelligence has driven demand for data centers to a frenzy. Within the data centers there is a need to move vast amounts of data quickly among processing units and memory. In theory, optical interconnects are well-suited to the task. However, much development remains to refine practical optical interconnects, integrated with processor and memory chips.

### BRIEF DESCRIPTION OF THE DRAWINGS

Embodiments of the disclosure have advantages and features which will be more readily apparent from the following detailed description and the appended claims, when taken in conjunction with the examples in the accompanying drawings, in which:

FIG. 1 shows fiber bundles connecting chips on different packages.

FIG. 2 is a schematic view of layers in an optical transmitter array.

FIG. 3 is a diagram of an aligned emitter, taper, and fiber core.

FIG. 4A is a diagram of part of an array of structures like that shown in FIG. 3.

FIG. 4B is a schematic, plan view of fiber cores aligned with tapers.

FIG. 5A is a diagram of a non-aligned fiber and taper array.

FIG. 5B is a schematic, plan view of the non-aligned fiber and taper array of FIG. 5A.

FIG. 6 is a ray-tracing simulation of light in a partially overlapping taper.

FIG. 7 is a schematic view of a fiber bundle coupled to an optical transmitter array.

FIG. 8 is a schematic view of a micro-LED display with a quantum dot (QD) conversion layer.

FIG. 9 is a diagram of a tapered micro-LED, tapered QD container, and microlens.

FIG. 10 is a diagram of a long tapered micro-LED and tapered light guide.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed

Optical chip-to-chip interconnects are based on sending signals via optical fiber from one chip to another. This may be done, for example, by connecting an optical data transmitter chip to a data source such as a graphics processing unit (GPU). The transmitter sends optical signals to an optical data receiver chip which is connected to a data sink such as another processing unit or high-bandwidth memory (HBM).

Each chip-to-chip data channel may be served by an optical fiber which is carefully aligned with an emitter at the transmitter end and a detector at the receiver end. Alternatively, a non-aligned bundle of fibers, rather than individually aligned fibers, may carry optical signals. Alignment tolerances may be relaxed when coupling a fiber bundle to an array of emitters or detectors because it is not necessary to know in advance which fibers in the bundle carry light between each emitter or detector.

In either the aligned or non-aligned case, light from emitters is coupled into optical fibers, and light exiting fibers is coupled onto detectors. Tapers, rather than microlenses, may perform this task. An array of tapers provides a flat surface to which fibers or fiber bundles may be glued without leaving air gaps. Tapers may be manufactured with standard semiconductor processing techniques and therefore may be created in perfect registry with underlying micro-LED or semiconductor detector arrays.

Tapers do not offer as much collimation power as microlenses of the same thickness. The exit angle of light from a taper is never narrower than the angle of the taper itself. The thickness of a taper is limited by the lateral pitch and taper angle, and beyond a certain thickness, adjacent tapers partially merge into each other. However, despite these limitations, tapers are an attractive replacement for microlenses in chip-to-chip interconnects as well as in micro-LED displays.

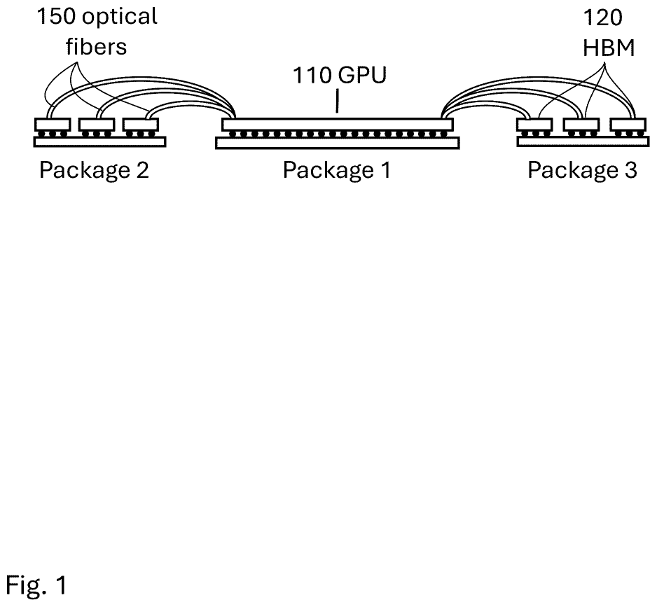

FIG. 1 shows optical fibers 150 connecting chips on different packages. The fibers may be bundles or individually aligned fibers. More generally, the optical connection may be made by individual fibers, fiber bundles, multicore fibers, arrays of fiber bundles or arrays of multicore fibers. The term “fiber core array” encompasses all of these possibilities, although we often refer to “fiber bundles” for simplicity. The fibers provide a dense, high-speed connection between a GPU 110 on package 1 and HBM 120 on packages 2 and 3. In the example of FIG. 1, wafer scale integration allows optical transmitter and receiver arrays to be integrated directly into the GPU 110 and HBM 120. Alternatively, separate transmitter and receiver chips may be included in each package and interfaced to the GPU 110 or HBM 120 via short electrical connections.

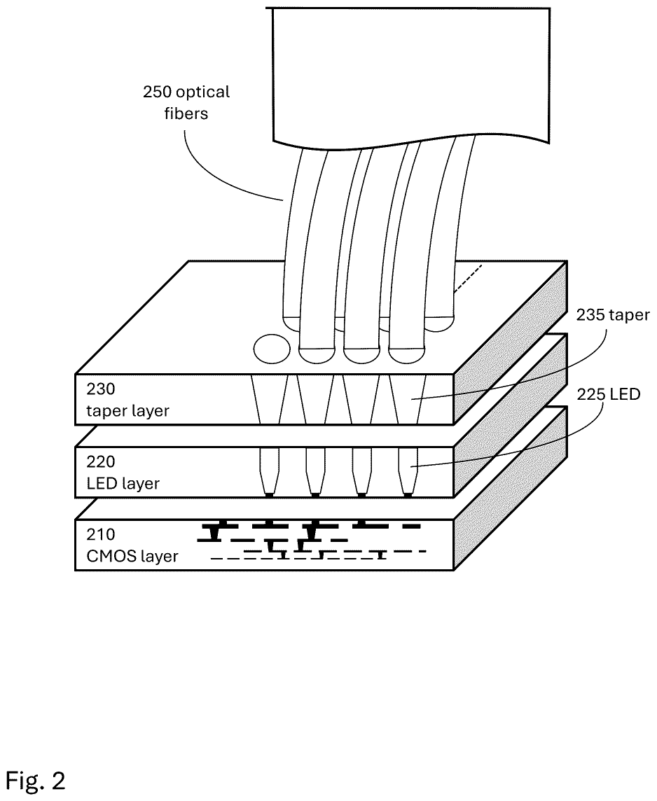

FIG. 2 is a schematic view of layers in an optical transmitter array. In FIG. 2, a CMOS driver layer 210 provides modulated electrical current to GaN micro-LEDs 225 which are defined in GaN epilayers grown on Si. The CMOS driver layer 210 is bonded to the micro-LED layer 220. Light emitted by the micro-LEDs 225 is guided by a taper array 235 into optical fibers 250. The taper array layer 230 may be formed on the micro-LED layer 220 during microfabrication. Each emitter is aligned with a corresponding optical fiber. Although FIG. 2 is schematic, it is readily apparent that the flat surface of the taper array 235 is convenient for coupling to the flat end face of an optical fiber 250.

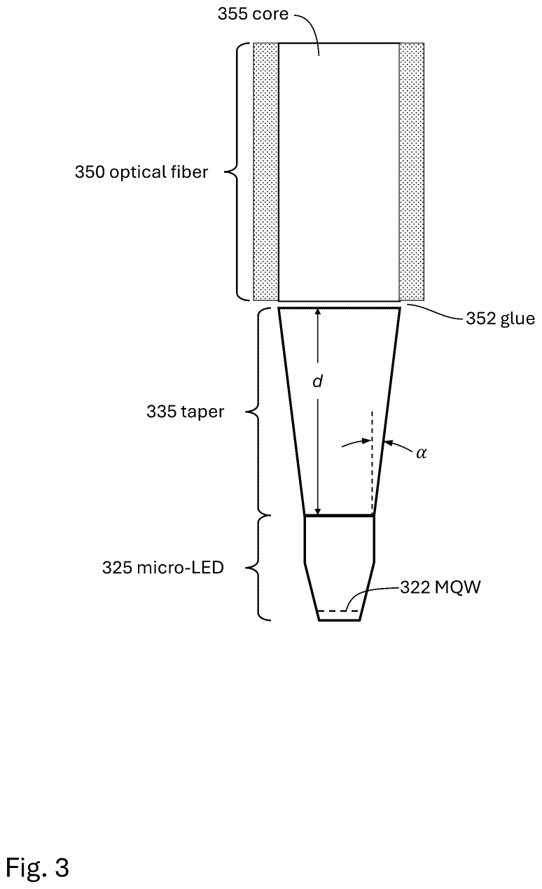

FIG. 3 is a diagram of an aligned emitter 325, taper 335, and fiber core 355. FIG. 3 is an enlarged view of one emitter element of the array of FIG. 2; however, in FIG. 3, the CMOS driver is not shown. The multiple-quantum-well (MQW) active region 322 of the micro-LED 325 is indicated by a dashed line. MQW epitaxial layers may be grown in a GaN-on-Si process. The micro-LED 325 may have a half-cavity design with sloped side walls to improve light extraction efficiency. The taper layer may be fabricated on top of micro-LEDs in a semiconductor fabrication process. For example, tapers 335 may be made by etching conical holes in an Al layer. The holes may be filled with a transparent dielectric such as SiO₂, in which case the tapers will be solid. Alternatively, tapers may be etched in a layer of SiO₂ and coated with a reflector such as Ag or Au, in which case the tapers will be hollow. Other ways of forming tapers 335 using semiconductor processes will be apparent to those skilled in microfabrication. The taper 335 may have the form of a conic frustum with thickness, d, and taper angle, α, as shown in the figure. Alternatively, it may have the form or a pyramid frustum. The angular spread of light rays narrows and approaches the taper angle as the rays undergo multiple reflections from the taper walls. The reduction in angular spread is proportional to the ratio of the areas of the input and output apertures of the taper. A cylinder has no collimating effect. A flat surface of the taper 335 abuts the cleaved or polished end of an optical fiber 350. The fiber may be glued 352 to the taper surface as shown in FIG. 3 or otherwise secured in position.

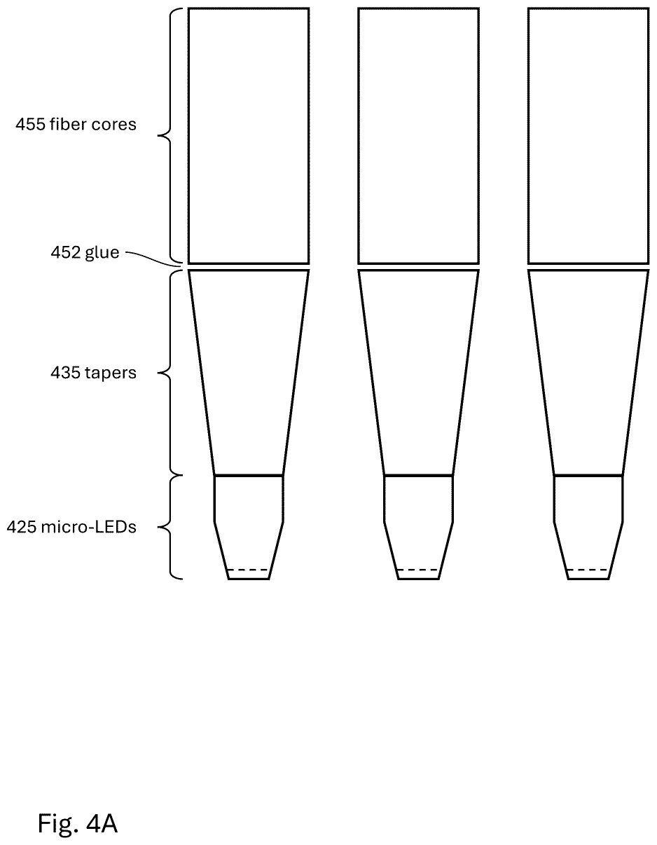

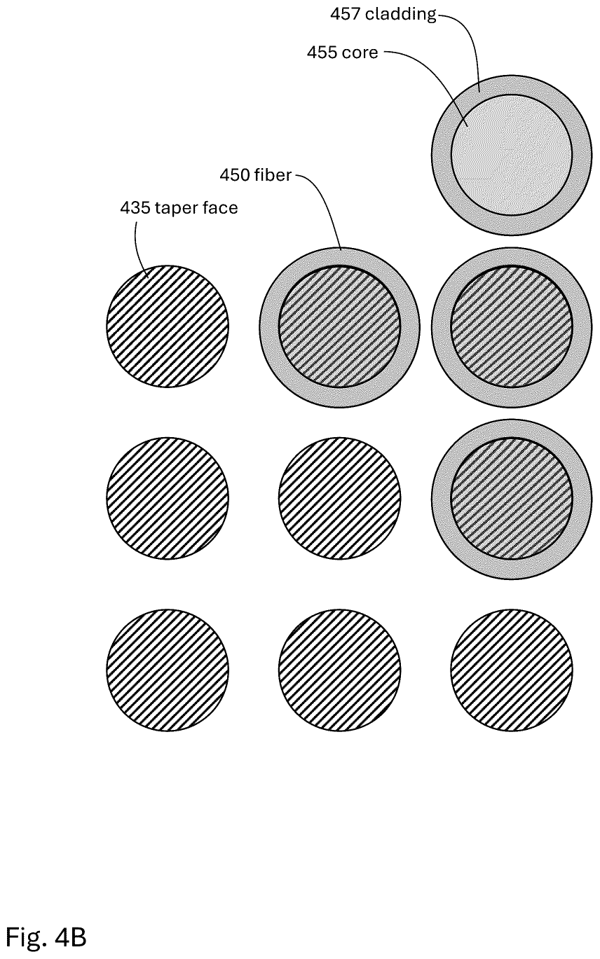

FIG. 4A is a diagram of part of an array of structures like that shown in FIG. 3. In FIG. 4A, only the cores 455 of the optical fibers are illustrated; the cladding has been omitted for convenience. An array of fibers 455 coupled to an array of emitters 425 via tapers 435 may include thousands of individual array elements. FIG. 4B is a schematic, plan view of fiber cores 455 aligned with tapers 435. FIG. 4B may be viewed as a cut through FIG. 4A at the level of the glue line 452. The pitch of emitters and fibers, in the arrays of FIGS. 4A and 4B, accommodates the full diameter of each fiber including its cladding layer. In FIG. 4B only three of the taper faces 435 have a corresponding fiber 450 coupled to them and one fiber (upper right fiber) is not coupled to any tapers 435.

It is not necessary for fibers, e.g. in a fiber bundle, to be carefully aligned with arrays of emitters or detectors and their tapers. It is not even necessary for the pitch or layout (e.g. square or hexagonal) of the emitter or detector arrays to match that of the fiber cores in the bundle. Wafer scale integration enables large, high-density arrays of very small micro-LEDs and optical detectors. For example, consider an array of 2-μm-diameter micro-LEDs on 4 μm pitch. If each micro-LED transmits data at 2 GB/s, the resulting data density is 125 TB/s/mm², or more than 10 TB/s through a 0.3 mm by 0.3 mm area. This high data density means that a fiber bundle coupled to wafer-scale integrated arrays can provide high bandwidth data communications even if a large fraction of the micro-LEDs or detectors are disabled and never used. In a less extreme example, micro-LEDs, tapers, fiber cores and optical detectors may be arranged on pitches of about 50 μm or less.

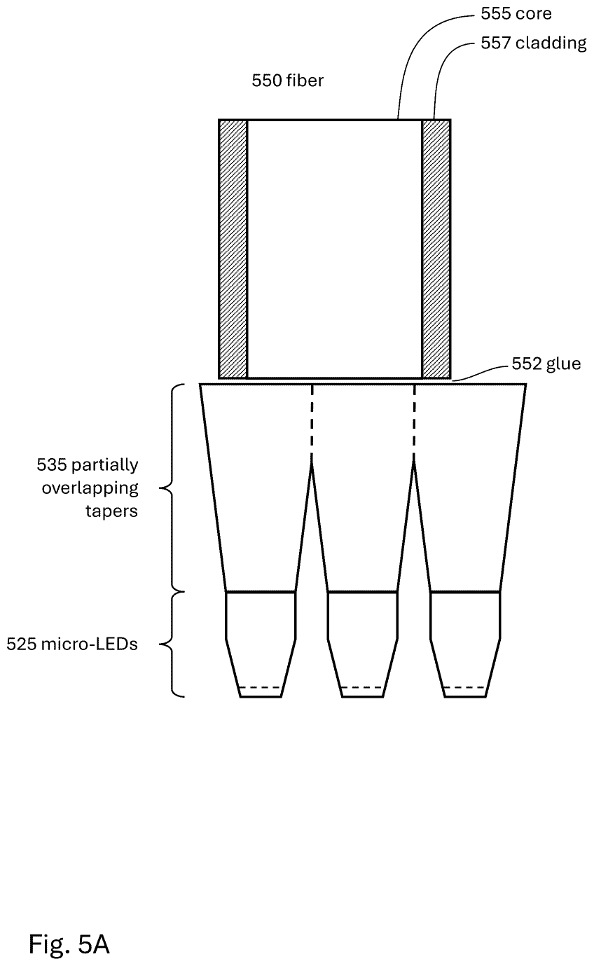

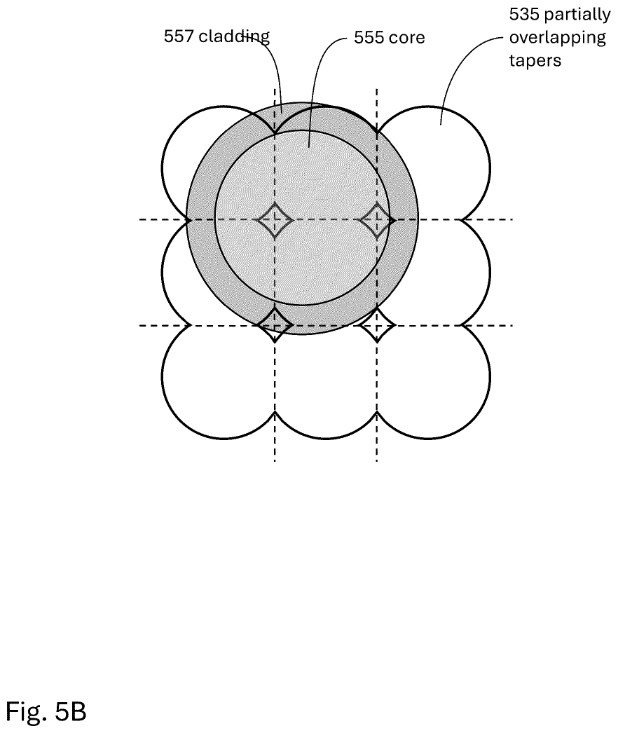

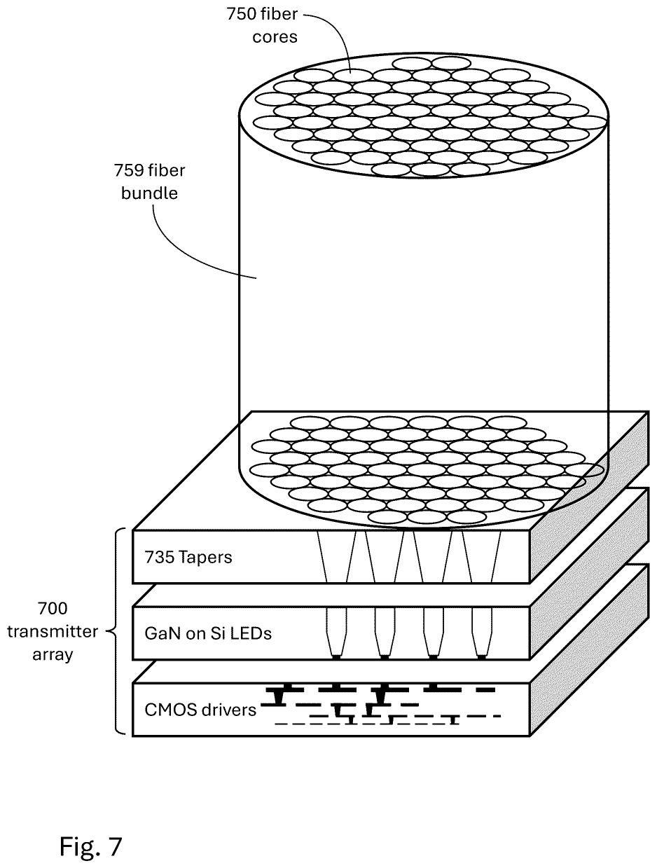

FIG. 5A is a diagram of a non-aligned fiber 550 and taper array 535. The situation in FIG. 5A is similar to that shown in FIG. 3, however the size of the fiber core 555 no longer matches the size of the output face of the tapers 535, and the tapers are spaced so close together that they partially overlap. There are more tapers 535 than micro-LEDs 525. The ratio of tapers 535 to micro-LEDs 525 is N:1, N>1, where N may or may not be an integer. If the micro-LED array 525 pitch is L and the LED diameter is D, then tapers 535 overlap if D+2 d tan(α)>L, where d and α are defined in FIG. 3. Only one fiber 550 is shown in FIG. 5A, however a bundle of fibers may be coupled to an array of emitters or detectors with (or without) partially overlapping tapers as shown in FIG. 7.

FIG. 5B is a schematic, plan view of the non-aligned fiber and taper array of FIG. 5A. FIG. 5B may be viewed as a cut through FIG. 5A at the glue line 552. In FIGS. 5A and 5B, tapers 535 partially overlap in the nearest neighbor (x, y) direction, but not the next nearest neighbor (diagonal) direction of the array.

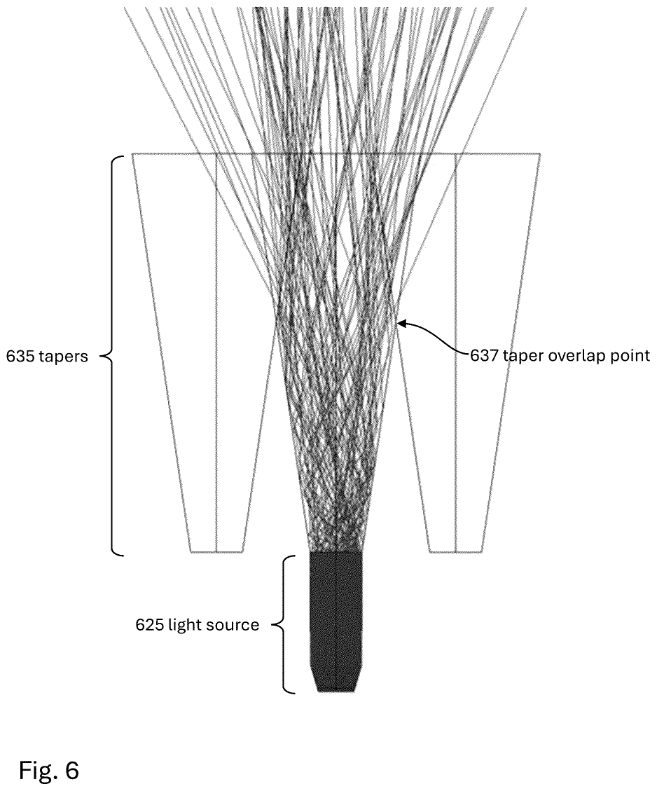

FIG. 6 is a ray-tracing simulation of light in a partially overlapping taper. Rays emitted from the light source 625 (a micro-LED and QD color converter in this example) are reflected by the walls of the taper 635. Up to the taper overlap point 637, the rays are confined to the taper into which they are launched. After the taper overlap point 637, the rays are no longer confined and some of them propagate at angles greater than the taper angle. However, all rays are confined to a much greater extent than they would be in the absence of either the taper or a microlens.

FIG. 7 is a schematic view of a fiber bundle 759 coupled to an optical data transmitter array 700. The fiber bundle 759 may contain several thousand fiber cores 750 in a hexagonal array. The layout and pitch of the fiber cores 750 does not necessarily match the layout and pitch of tapers 735 in the transmitter array. The taper layer 730 presents a flat surface to the flat end surface of the fiber bundle 759, and the two surfaces may be glued or otherwise held together.

So far tapers have been discussed in the context of coupling light from micro-LED emitters into optical fibers. In analogy, tapers may also couple light exiting optical fibers onto semiconductor optical detectors. In a detector array, optical fibers may be aligned to specific tapers, or a non-aligned bundle of fibers may be coupled to a taper array. The layout and pitch of the fiber cores in a fiber bundle need not necessarily match the layout and pitch of tapers in the detector array. The detector array may be implemented in a layer of a CMOS process and communicate directly with downstream electronics. With respect to FIG. 2, in the analogous figure for an integrated optical data receiver, the taper layer 230 would still be a taper layer, the LED layer 220 would be a photodetector layer that contains an array of photodetectors rather than LEDs as the optoelectronic devices, and the CMOS layer 210 would be a CMOS layer that contains transimpedance amplifiers and possibly additional circuitry. In this case, the photodetector layer and CMOS layer may be implemented as a single combined layer.

We have seen that taper arrays may be used in integrated optical data modules, including both transmitter modules and receiver modules, for high-speed chip-to-chip optical interconnects. Taper arrays may also replace microlens arrays in micro-LED displays. Any or all of three parts of a display pixel may be tapered: a micro-LED, a quantum dot container, or a separate taper light guide section.

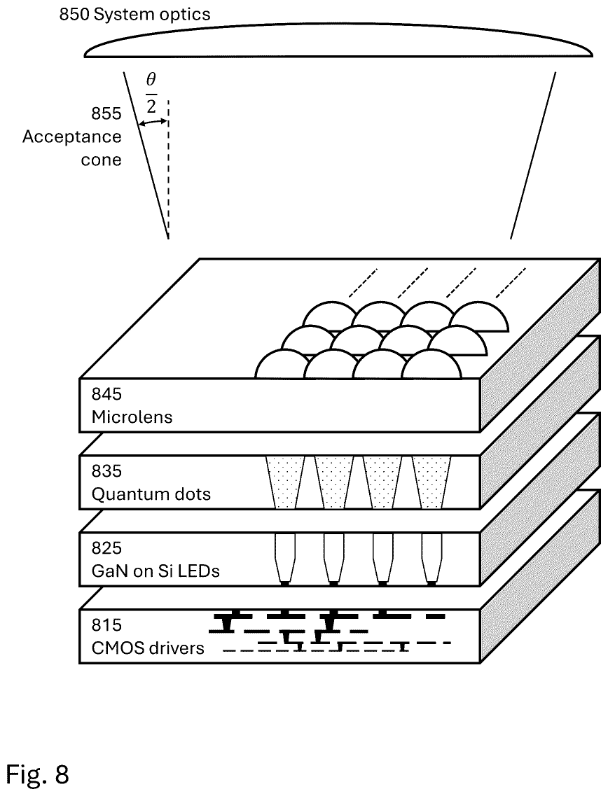

FIG. 8 is a schematic view of a micro-LED display with a quantum dot (QD) color-conversion layer. From bottom to top, the display includes CMOS driver circuitry 815, micro-LEDs 825, quantum dot color conversion materials 835 and optional microlenses 845. If microlenses are omitted, the structure looks like that shown in FIG. 7, without the fiber bundle. In this example, the devices 825 are supported by the silicon substrate for the CMOS drivers 815. The micro-LEDs 825 may be loaded onto the silicon substrate via pick-and-place techniques, or an array of micro-LEDs may be fabricated and the entire array connected to the driver circuitry.

In this example, the micro-LEDs 825 all emit the same color light. They may be gallium nitride blue LEDs. The color conversion materials 835 convert the light from the micro-LEDs 825 to different colors, for example to red and green for RGB displays. The micro-LEDs 825 and color conversion materials 835 form the emitters of FIG. 8. The different color emitters may be arranged into color pixels. In this example, the color conversion materials are quantum dots 835. Other examples of color conversion materials may include phosphors, quantum wires, or quantum plates.

As one example, a continuous LED layer (e.g., epitaxial layers) is first fabricated and then patterned into individual LEDs 825. In a micro-LED array, the light-emitting area of individual emitters may be less than about 5 μm on a side (25 μm² in area) or even as small as about 1 μm (1 μm² in area) or less. The pitch or lateral distance from an edge of an LED to the corresponding edge of the neighboring LED may also be less than about 5 μm (microns), although micro-LEDs may also be arranged on larger pixel pitches.

The quantum dot color conversion layer 835 changes the color of the light emitted by the LEDs 825. For example, the QD layer may convert blue light emitted by an LED into red light. The color conversion 835 layer may be patterned into QD containers which are aligned with the LEDs 825. In some cases, light emitted by different LEDs (or even adjacent LEDs) may be converted into different colors. This may be accomplished by filling QD containers in the color conversion layer with different types of quantum dots. Some light emitters may not include color conversion, for example blue LEDs that produce the blue light component of color pixels.

The CMOS driver circuitry 815 receives digital signals representing the color pixels. The drivers control the brightness of the micro-LEDs 825 by generating drive currents for the micro-LEDs based on the received digital signals. This controls the brightness and color of each color pixel. In this example, there is also one microlens 845 for each emitter. The microlens collects light from the light emitter and couples it into the acceptance cone 855 (full angle θ) for the optics for the rest of the system 850. In another example, there may be no microlens. In that case the taper narrows the light emitted by the micro-LED and couples into the acceptance cone.

Micro-LEDs, especially at very small sizes of 5 μm or less, may be cylindrically symmetric. When a micro-LED display is viewed under high magnification, the individual LEDs may look like round dots. Accordingly, the containers which hold quantum dots may be designed as cylinders filled with quantum dots.

However, a cylinder may not be the optimal shape for QD containers in micro-LED display applications. On the contrary, container designs in which the cross-sectional area varies along the length of the container, may provide better performance. Even if the QD container is axially symmetric (i.e., the cross-section is always a circle), the diameter of the container may vary along its length. In one approach, the QD container 835 may have the form of a conic frustum.

One way that the shape of the QD container 835 may increase the overall efficiency of the display is by coupling more light into the acceptance cone of the system. For example, augmented reality (AR) glasses and goggles use light directed into a specified acceptance angle, which may be as narrow as 30 to 40 degrees, full width. Light outside this acceptance cone is not coupled into the rest of the system and is wasted.

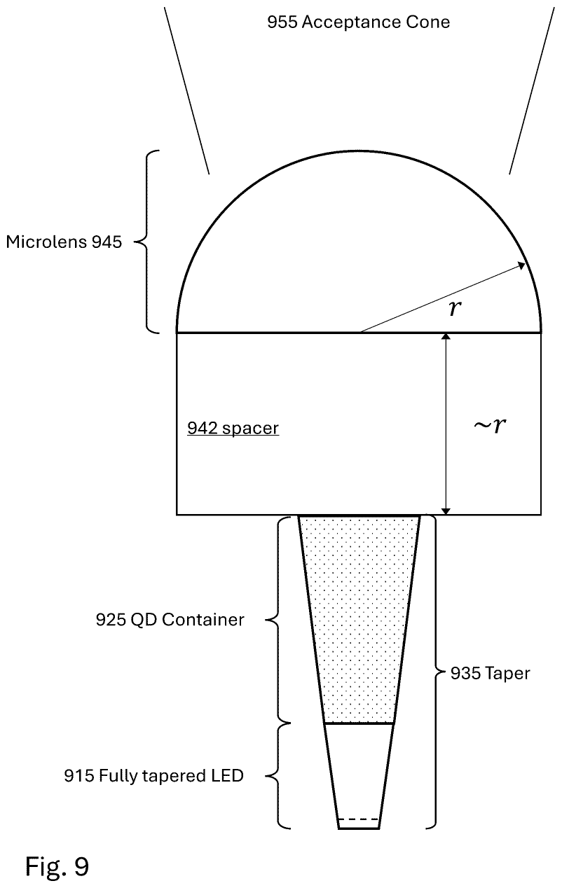

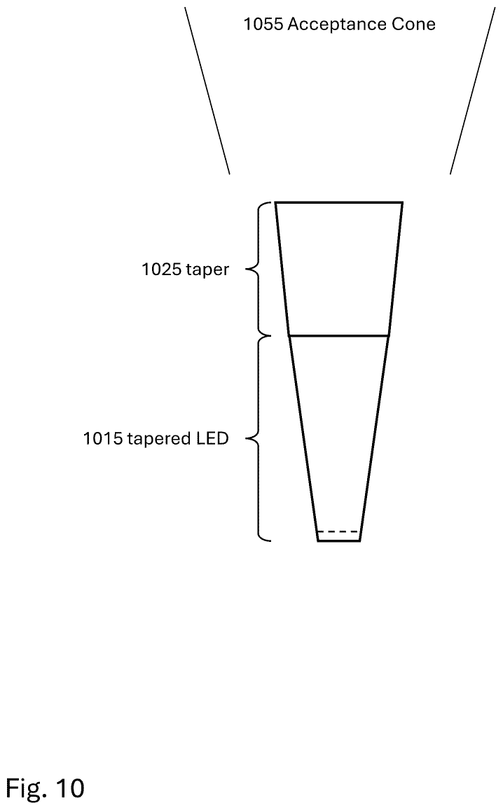

FIGS. 9 and 10 illustrate two examples of tapers in micro-LED display sub-pixels. FIG. 9 is a diagram of a tapered micro-LED, tapered QD container, and microlens. FIG. 10 is a diagram of a long tapered micro-LED and tapered light guide.

In FIG. 9 a taper 935 works in combination with a microlens 945 to collimate light into a downstream optical acceptance cone 955. The micro-LED 915 and the QD container 925 tapers are conic frusta, however either one could have a different shape such as a cylinder. The microlens 945 is most effective when its diameter is two or more times the diameter of taper 935, measured at the interface between the microlens and the taper. The microlens may be hemispherical with radius, r, as shown in the figure, and spaced apart from the underlying QD container 925 by approximately r, for example by spacer 942.

In FIG. 10 the micro-LED 1015 is long, tapered and coupled to a tapered light guide 1025. The tapers may be conic frusta. No microlens is necessary or included. The light taper 1025 may be filled with a high-index material to reduce internal reflections at the LED-taper interface. Making the micro-LED 1015 longer than otherwise necessary, at least twice as long as its diameter for example, leaves more tapered path length within the high-index material of the LED. This leads to angles of incidence closer to normal to the interface between the LED and the tapered light guide, and therefore less light lost to total internal reflection in the LED. Since no quantum dots are included in this example, the light emitted into the acceptance cone 1055 has the same color as that emitted by the LED.

Other combinations of LEDs and tapers are possible. In general, a micro-LED may be cylindrical (no taper), partially tapered, or fully tapered. A tapered LED may be made longer than otherwise necessary to provide enhanced light guiding within the high-index material of the LED. A quantum dot container, if one is included may similarly be cylindrical, partially tapered, or fully tapered. A quantum dot container may also have a waist as described in “Quantum dot containers for micro-LED displays”, U.S. Ser. No. 18/961,183, to Bhat, filed on Nov. 26, 2024, and incorporated herein by reference. A tapered light guide, distinct from any quantum dot container, may replace or augment a microlens. If a microlens is placed at the output face of a taper, e.g. as in FIG. 9, then it is most effective if its diameter is at least twice the diameter of the taper. Many combinations of LED, QD container, and tapered light guide are effective.

Tapers offer an alternative to microlenses in micro-LED arrays and detector arrays. They present a flat surface to fiber optics and are more easily integrated into semiconductor fabrication processes than are microlenses. Micro-LED arrays with taper arrays are useful in high bandwidth chip-to-chip communication and in micro-LED displays.

Although the detailed description contains many specifics, these should not be construed as limiting the scope of the invention but merely as illustrating different examples. It should be appreciated that the scope of the disclosure includes other embodiments not discussed in detail above. Various other modifications, changes and variations which will be apparent to those skilled in the art may be made in the arrangement, operation and details of the method and apparatus disclosed herein without departing from the spirit and scope as defined in the appended claims. Therefore, the scope of the invention should be determined by the appended claims and their legal equivalents.

1. An integrated optical data module comprising:
a first layer containing an array of electronic circuits;
a second layer containing an array of optoelectronic devices electrically connected to the electronic circuits; and,
a third layer containing an array of optical tapers, the third layer formed on the second layer with the array of tapers positioned to couple light between the array of optoelectronic devices and a fiber core array.

2. The integrated optical data module of claim 1 where the module is a transmitter, the electronic circuits comprise CMOS drivers, the optoelectronic devices comprise micro-LEDs, the second layer is bonded to the first layer, and the CMOS drivers modulate current supplied to the micro-LEDs and the micro-LEDs emit light into the tapers.

3. The integrated optical data module of claim 1 where the module is a receiver, the electronic circuits comprise transimpedance amplifiers, the optoelectronic devices comprise optical detectors, the first and second layers are implemented as a combined layer, and the optical detectors detect light funneled from the tapers and produce current amplified by the transimpedance amplifiers.

4. The integrated optical data module of claim 1 where the third layer contains a top surface of the tapers that is flat.

5. The integrated optical data module of claim 1 where an angular distribution of light on an optical fiber side of the tapers is narrower than an angular distribution of light on optoelectronic device side of the tapers.

6. The integrated optical data module of claim 1 where the array of optoelectronic devices and the array of tapers are aligned to each other and share a common pitch which is 50 μm or less.

7. The integrated optical data module of claim 6 where the tapers are not overlapping.

8. The integrated optical data module of claim 6 where the tapers are partially overlapping.

9. The integrated optical data module of claim 1 where the tapers are frustums of cones.

10. The integrated optical data module of claim 1 where the tapers are frustums of pyramids.

11. The integrated optical data module of claim 1 where the tapers are solid.

12. The integrated optical data module of claim 1 where the tapers are hollow.

13. The integrated optical data module of claim 1 where there is a 1:1 correspondence of tapers to optical fibers.

14. The integrated optical data module of claim 1 where a number of tapers is greater than a number of optical fibers.

15. The integrated optical data module of claim 14 where the array of optical tapers and the fiber core array are non-aligned.

16. The integrated optical data module of claim 14 where there is an N:1 correspondence of tapers to optical fibers, and N is greater than one.

17. A high-speed data transmission system comprising:
a first integrated circuit chip comprising an optical data transmitter comprising:
a first layer containing an array of CMOS drivers;
a second layer containing an array of micro-LEDS electrically connected to the CMOS drivers, the second layer bonded to the first layer; and
a third layer containing a first array of optical tapers, the third layer formed on the second layer with the first array of tapers positioned to receive light from the array of micro-LEDS;
a second integrated circuit chip comprising an optical data receiver comprising:
a fourth layer containing an array of transimpedance amplifiers;
a fifth layer containing an array of optical detectors electrically connected to the transimpedance amplifiers; and
a sixth layer containing a second array of optical tapers, the sixth layer formed on the fifth layer with the second array of tapers positioned to funnel light to the array of optical detectors; and
a fiber core array having two ends, a first end coupled to the optical data transmitter and a second end coupled to the optical data receiver, the fiber core array carrying optical signals from the optical data transmitter to the optical data receiver.
